(19) United States
(12) Patent Application Publication
(10) Pub. No.: US 2024/0308265 A1
(43) Pub. Date: Sep. 19, 2024

(54) Foldable A4/Letter size Box File

(71) Applicant: TEH EIK SONG, Georgetown (MY)

(72) Inventor: TEH EIK SONG, Georgetown (MY)

(21) Appl. No.: 18/122,182

(22) Filed: Mar. 16, 2023

(51) Int. Cl. B42F 7/14; B65D 5/20

(52) U.S. Cl. CPC B42F 7/14; B65D 5/20; B65D 2313/04

(57) ABSTRACT

The present invention discloses a novel structure of box file that is extendable, collapsible, and portable. With its unique magnetic closure, the management of documents is quite easy and requires minimal effort from the user. The assembly is designed to hold A4/letter size documents and is developed from high-quality materials ensuring its best working over a longer period of time.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to a box file and more particularly relates to a foldable A4/Letter size box file equipped with a clip and a magnetic closure for easier document placing and handling.

### Description of the Related Art

A box file, which has a certain inside space to receive therein objects, has previously been used when required to file documents in an office work. The known box file is generally defined by a bottom plate, a pair of side walls respectively connecting with both sides of the bottom plate, and a back wall connecting with these side walls and back wall in a state that it opens into the air at the top portion to have a certain hollow receiving area. These box files are made of hard paper or plastic material to protect the objects from damage effectively using the material hardness and to make good use of space in conformity with types of objects.

By looking at prior art multiple advancements have been seen in similar regards. For instance, a WO patent 1,996,036498A1 relates to a box file (10) is formed by first and second box forming members (11, 12) which are formed to enable assembling with each other. The first box forming member (11) comprises a bottom wall (16) and a rear wall (17) provided between a pair of side walls (14, 15), and punched portions (14B, 16A, 17A) are formed in the side wall (14), bottom wall (16) and the rear wall (17), respectively. The second box forming member (12) comprises a bottom wall (21) and a rear wall (22) provided contiguous to side walls (20), and a partition wall (24) provided between the bottom wall (21) and the rear wall (22). The partition wall (24) can pass through the punched portion (14B), and the bottom wall (21) and the rear wall (22) of the second box forming member (12) are adapted to be received in the punched portions.

A U.S. Pat. No. 5,707,003A Box file relates to a Box file (10) composed with first and second box forming components (11, 12) capable of being coupled together. First box forming component (11) has bottom plates (16) and back walls (17) between a pair of side walls (14, 15) in a state that side walls (14), bottom walls (16) and back walls (17) are provided with cut-off portions (14B, 16A, 17A). Second box forming component (12) has bottom plates (21) and back walls (22) connected with the side walls (20) and partition walls (24) provided between bottom plates (21) and back walls (22). Partition walls (24) are designed to pass over cut-off portions (14B) and bottom plates (21) and back walls (22) of second box forming component (12) are received in cut-off portions (16A, 17A).

An EP U.S. Pat. No. 771,676B1 relates to Box file with a first box forming component (11) having a pair of side walls (14,15), at least one bottom plate (16) and at least one back wall (17) provided between the side walls to provide an opening at least at a top portion thereof

There are multiple solutions that have been presented in the prior art. However, the utility of these systems has not been seen in advanced form. Looking at the prior art and market requirements, the need exists for an advancement that allows better box file structures that are not only portable but also is easier to manage and file/retrieve documents.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore an object of this invention to provide a new and improved form of box file structure that provides various advancements.

It is another object to provide an improved box file structure that is a foldable A4/Letter size box file that is portable and convenient for organizing documents

It is also the objective of the invention to provide a box file wherein the filing, organizing, and retrieving of documents is easier with a clip and a magnetic closure.

It is a further object of the present invention to provide an improved structure that is relatively inexpensive to manufacture.

It is a still further object of the present invention to provide an improved box file developed from high-quality material to provide sustainable and long-lasting performance.

It is also the objective of the invention to provide an assembly that is of durable configuration and maintain its effectiveness over a longer period of time.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 discloses the view of the complete assembly as per preferred embodiments of the invention.

FIG. 2 discloses the formed view of the box file as per preferred embodiments of the invention.

FIG. 3 discloses another open view showing various configurations as per preferred embodiments of the invention.

FIG. 4 discloses another flat folded view showing various configurations as per preferred embodiments of the invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide an improved box file structure that is completely foldable, portable, and provides magnetic closure to provide enhanced utility to the users.

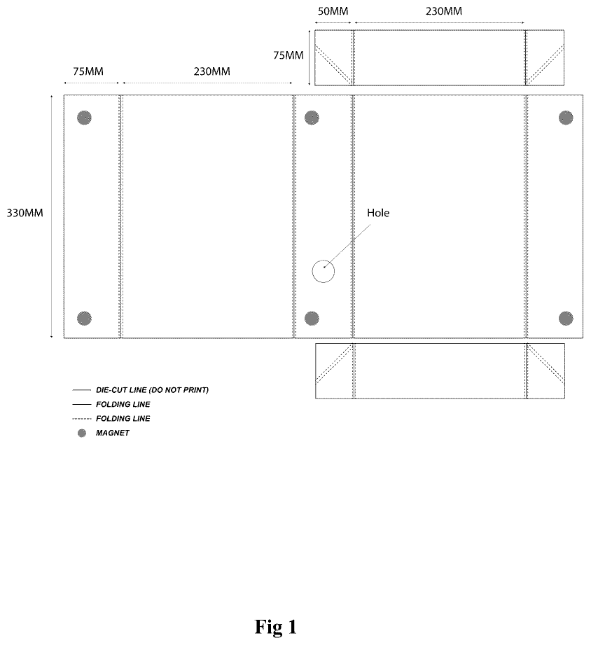

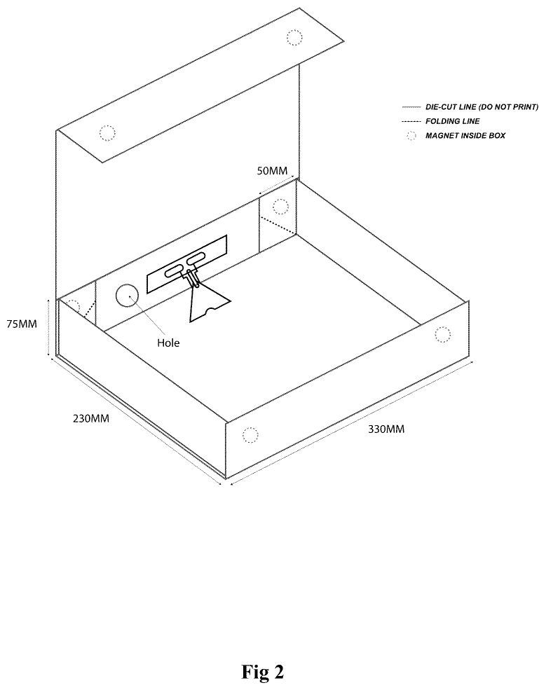

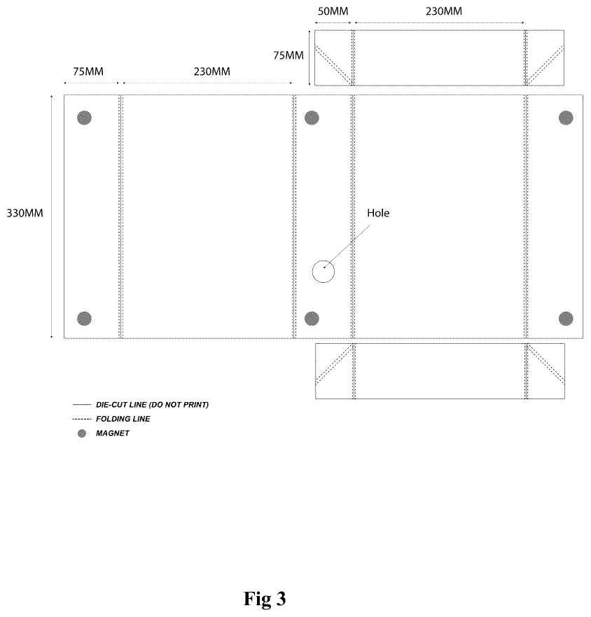

According to the invention, FIG. 1-3 are showing multiple configurations of the file. FIG. 1 is a perspective view of the appearance of the overall composition of a box file in the first embodiment. As can be seen from the drawing, the box file is essentially made up of a first box-forming component made of a suitable plastic material adapted to be integrally coupled with the first box-forming component.

The first box-forming component is, defined by a pair of side walls each of which is laterally facing the other, bottom plates laid across the bottom edges of the side walls to serve as a mounting surface, and back walls connected between the side walls.

The box file as per its further embodiments includes 4 embedded magnet discs and 6 embedded magnetic discs. These magnetic closures are in circular shape and are provided to open/close the assembly conveniently. These magnetic closures are made of high-quality material, ensuring that it remains strong and reliable even after repeated use. The file further includes a clip for holding paper documents in place inside the box file.

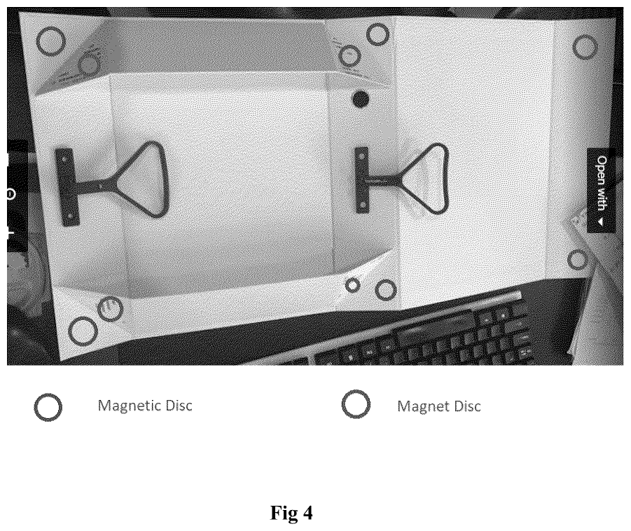

As shown in FIG. 4, the proposed box file can be folded flat, allowing it to be stored conveniently and transported/stored in an efficient manner allowing the savage of space with no damage to the structure of the box file.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A magnetic box file comprising:
a pair of side walls each of which is laterally facing the other,
bottom plates laid across the bottom edges of the side walls to serve as a mounting surface, and,
back walls connected between the side walls thereof.

2. the box file with a magnetic closure as per claim 1, wherein the file is completely foldable and portable.

3. the box file with a magnetic closure as per claim 1, wherein the file includes clip and magnetic discs.

4. the box file with a magnetic closure as per claim 1, wherein the file body and clip are made of sturdy plastic.

5. the box file with a magnetic closure as per claim 1, wherein the file body is made of lightweight but durable material.

6. the box file with a magnetic closure as per claim 1, wherein the file is designed to hold A4/Letter size documents.

7. the box file with a magnetic closure as per claim 1, wherein the file is universal in nature and can be used in a variety of settings conveniently.

8. the box file with a magnetic closure as per claim 1, wherein with magnetic disc and conventional plastic clip, addition and withdrawal of documents is quite easy as compared to traditional ways.

9. the box file with a magnetic closure as per claim 1, wherein the file can be carried easily in a backpack, briefcase, or handbag.

10. the box file with a magnetic closure as per claim 1, wherein the file structure is collapsible and can be instantly folded and stored away to save space, once not in use.
